(19) United States
(12) Patent Application Publication
(10) Pub. No.: US 2013/0182731 A1
(43) Pub. Date: Jul. 18, 2013

(54) Fast Wavelength Switching

(71) Applicants: Neil David Whitbread, Towcester (GB); Andrew Cannon Carter, Blisworth (GB)

(72) Inventors: Neil David Whitbread, Towcester (GB); Andrew Cannon Carter, Blisworth (GB)

(73) Assignee: OCLARO TECHNOLOGY LIMITED, Caswell, Towcester (GB)

(21) Appl. No.: 13/825,295

(22) PCT Filed: Sep. 26, 2011
(86) PCT No.: PCT/GB2011/051812

§ 371 Date: Mar. 29, 2013

(30) Foreign Application Priority Data
Sep. 27, 2010 (GB) 1016213.9

(51) Int. Cl. H01S 3/13

(52) U.S. Cl. CPC H01S 3/13
USPC 372/20

(57) ABSTRACT

There is described a laser assembly for providing light at a switchable output wavelength. The assembly comprises first and second tuneable lasers, each configurable to emit light at a laser wavelength chosen from a range of wavelengths. Light is transmitted from the first laser while the second laser is retuned to change the chosen laser wavelength thereof. Each laser comprises one or more thermally sensitive control components for controlling the operation of the laser and an additional component electrode located adjacent to at least one of the one or more control components. The laser is configured so that the sum of electrical currents supplied to each control component and its corresponding additional component remains substantially constant in use.

### TECHNICAL FIELD

The present invention relates to fast wavelength switching of light for use in fibre optic applications. In particular, the invention relates to fast wavelength switching of laser light provided to a modulator.

### BACKGROUND

In this specification the term “light” will be used in the sense that it is used in optical systems to mean not just visible light, but also electromagnetic radiation having a wavelength outside that of the visible range.

In fibre-optic communications, wavelength-division multiplexing (WDM) is a technology which multiplexes multiple optical carrier signals on a single optical fibre by using different wavelengths of laser light to carry different signals. This allows for a multiplication in capacity, in addition to enabling bidirectional communications over one strand of fibre.

A signal is transmitted along an optical fibre by using a modulator to impose a modulation signal on light to be passed through the fibre. Such signals are usually transmitted as consecutive data packets. It is therefore desirable to switch the wavelength of light provided to the modulator, between consecutive packets, so that each packet (or each pair of packets, or every three packets, etc.) is at a different wavelength. The time available between packets is very short (10 ns or less for a 10 Gb/s transmission system), and very fast wavelength switching is therefore desirable.

Light for fibre-optic communications is often provided by tuneable semiconductor lasers having Distributed Bragg Reflectors (DBRs). A typical laser of this type is described, for example, in U.S. Pat. No. 7,145,923. This laser has four principal sections: a gain section, a phase change section, a phase shifted rear DBR which produces a comb of reflectance peaks at separated wavelengths, and a chirped front DBR which reflects over a range of wavelengths. The wavelength of light transmitted by the laser can be controlled by modifying current injected to the front DBR, phase change section, and rear DBR, although the largest change in current required to effect a wavelength change is at the rear (comb) DBR. An alternative is described, for example, in U.S. Pat. No. 5,379,318, which describes a tuneable laser in which two segmented DBRs, one on either side of a gain section, are used that each produce a comb-like reflection spectrum, and the two spectra have interleaved peaks, such that an individual peak from one segment can be tuned to overlap that of a peak in the other DBR, in order to create and define an optical cavity that is above the lasing threshold.

Fast wavelength switching using current injection in semiconductor DBR lasers has been extensively studied with <10 ns switching speeds demonstrated (Ronan O'Dowd, Photonic Network Comm. 2(1) p. 97). These demonstrations, however, do not accommodate the subsequent slow wavelength drift due to the thermal transient caused by the change in current injected to the laser. For example, if the current injected to the rear DBR is increased over 10 ns, the laser will continue heat up, and the thermal settling time could be 1 μs or more. The emitted wavelength will continue to change over this period.

Fast wavelength locking schemes can be employed to mitigate this problem where switching times between accurate ITU channels of ˜5 μs have been published (Ben Puttnam et al, OFC 2006). However, the problem still exists that a fast wavelength switch to a new stable wavelength has not been achieved.

### SUMMARY

It is an object of the present invention to address, or at least alleviate, the problems described above.

In accordance with a first aspect of the present invention there is provided a laser assembly for providing light at a switchable output wavelength. The assembly comprises first and second tuneable lasers, each configurable to emit light at a laser wavelength chosen from a range of wavelengths. The assembly is configured to transmit light from the first laser while the second laser is retuned to change the chosen laser wavelength thereof. The output wavelength may then be switched by switching to transmission of light from the second laser at the changed laser wavelength. Each laser comprises one or more thermally sensitive control components for controlling the operation of the laser and an additional component electrode located adjacent to at least one of the one or more control components. The laser is configured so that the sum of electrical currents supplied to each control component and its corresponding additional component electrode remains substantially constant in use.

Similarly, while the light from the second laser is transmitted, the first laser may be retuned so as to change the laser wavelength thereof. The lasers may then be used in sequence to provide light at wavelengths in discrete steps. The overall current supplied to a component and its additional electrode should be the same while a laser is being retuned as when it is transmitting.

Each laser may comprise a rear reflector, gain section and front reflector, one or more of which may be the thermally sensitive components referred to above.

Each additional control electrode may be located sufficiently close to its corresponding control component so that there is strong thermal coupling between the additional control electrode and the corresponding control component. For example, the additional component electrode may be within approximately 10 μm of the rear reflector.

The lasers may be Digital Supermode Distributed Bragg Reflector lasers, in which the rear reflectors are phase change Bragg reflectors and the front reflectors are chirped Bragg reflectors. The additional component electrodes may then be located adjacent to the phase change Bragg reflectors.

The lasers may be Sampled Grating Distributed Bragg Reflector lasers in which the front and rear reflectors are sampled Bragg gratings. Any other suitable tuneable laser may also be used.

First and second transmission switches, for example SOAs, may be coupled to outputs of the first and second lasers respectively and configured to selectively block and transmit light emitted by their respective laser. The one or more control components may then include the transmission switches and the additional control electrodes may include first and second additional switch electrodes located adjacent the first and second transmission switches respectively and configured so that the sum of electrical currents supplied to each transmission switch and its corresponding additional switch electrode remains substantially constant while the switch is operated to change state between transmission and blocking of light. Each additional switch electrode may be located within approximately 10 μm of its corresponding transmission switch so that there is strong thermal coupling between the additional switch electrode and the corresponding transmission switch.

Each laser may be monolithically integrated on a single substrate with its corresponding transmission switch and one or more additional component electrodes. Both lasers (including the additional electrodes) may be monolithically integrated on a single substrate. The lasers may be spaced apart by a distance equal to or greater than the thickness of the substrate.

In accordance with an embodiment of the invention there is provided a wavelength switchable transmission assembly. The transmission assembly comprises the laser assembly described above and a modulator, configured so that light emitted from the laser assembly is propagated into the modulator.

The assembly may further comprise an optical coupler/splitter having two inputs and two outputs, wherein light emitted from the first laser is propagated into one of the inputs and light emitted from the second laser is propagated into the other of the inputs, and wherein the two outputs are coupled to modulation arms of the modulator.

Alternatively, the assembly may comprise a combiner having two inputs and at least one output wherein light emitted from the first laser is propagated into one of the inputs and light emitted from the second laser is propagated into the other of the inputs. The combiner may be configured so that light entering either of the inputs is transmitted from the output.

The laser assembly and modulator may be monolithically integrated on a single substrate.

In accordance with another aspect of the present invention there is provided a method of transmitting light having a wavelength which changes in discrete steps over time. While light is transmitted at a first wavelength from a first laser, a second laser is retuned to emit light at a second wavelength. Each laser includes one or more thermally sensitive control components. In order to switch wavelength, transmission of light at the first wavelength from the first laser is blocked, and transmission of light at the second wavelength from the second laser is started. When the first or second laser is retuned, a current injected to at least one of the one or more thermally sensitive control components of that laser is changed. At the same time, a current directed to an additional component electrode located adjacent to the at least one control component is also changed so that the sum of the currents supplied to the control component and additional component electrode remains substantially constant.

The first laser may be retuned to emit light at a third wavelength while the light at the second wavelength is transmitted from the second laser.

Each laser may comprise a rear Distributed Bragg Reflector, gain section and front Distributed Bragg Reflector, and the one or more thermally sensitive control components may include one or both of the reflectors.

Controlling transmission of light from the lasers may be carried out by changing current injected to semiconductor optical amplifiers coupled to outputs of the lasers. Current directed to dummy switch electrodes located adjacent to the amplifiers may also be changed so that the total current supplied to one of the amplifiers and its associated dummy switch electrode remains substantially constant.

In one embodiment the method further comprises propagating light emitted from the first or second laser into a modulator, applying a signal to modulate the light, and transmitting the modulated light.

The signal may comprise data packets. The step of switching wavelength may be effected between adjacent data packets.

### BRIEF DESCRIPTION OF THE DRAWINGS

Some preferred embodiments of the invention will now be described by way of example only and with reference to the accompanying drawings, in which:

FIG. 1 is a schematic illustration of a laser assembly and modulator;

FIG. 2 is a cross section through the assembly of FIG. 1; and

FIG. 3 is a schematic illustration of an alternative arrangement of the laser assembly and modulator.

### DETAILED DESCRIPTION

The use of two tuneable lasers allows one laser to be switched in wavelength whilst the other is active. This means that the switching time requirement is relaxed from <10 ns (time between adjacent data packets) to >200 ns (duration of a data packet). This time could further be increased depending on the latency requirement.

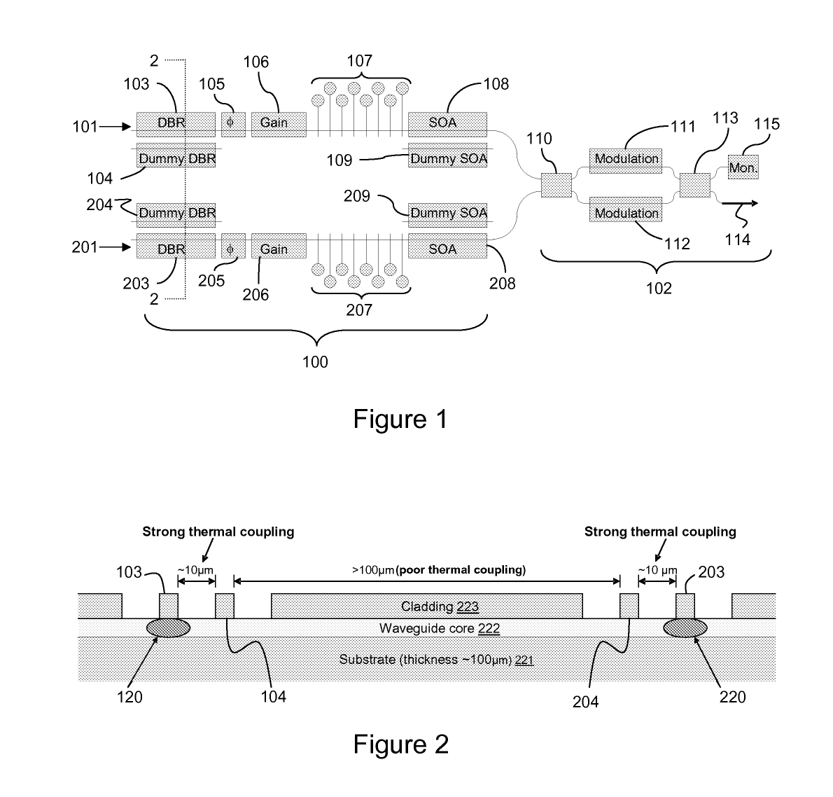

FIG. 1 is a schematic illustration of a laser assembly 100 comprising first and second Digital Supermode Distributed Bragg Reflector (DS-DBR) lasers 101, 201 configured to transmit light towards a Mach-Zender (MZ) modulator 102. In this example the lasers 101, 201 are generally of the type described in U.S. Pat. No. 7,145,923, although it will be appreciated that the invention can be applied to any suitable type of tuneable laser, and in particular to a Sampled Grating Distributed Bragg Reflector (SG-DBR) laser. The figure is a top view of electrodes overlying the lasers deposited on a substrate (not shown).

Each laser 101, 201 comprises a rear DBR 103, 203, phase change section 105, 205, gain section 106, 206 and front DBR 107, 207. The rear DBRs 103, 203 are phase 31851460-1-data) bot shifted gratings adapted to produce a comb of reflective peaks, and the front DBRs 107, 207 are chirped gratings adapted to reflect over a range of wavelengths.

First and second Semiconductor Optical Amplifiers (SOAs) 108, 208 are provided after the output of each laser 101, 201 for switching transmission from their respective laser 101, 201 on or off.

The output of the laser assembly 100 is directed into the MZ modulator 102. The MZ modulator 102 comprises an input 2×2 Multimode Interference (MMI) coupler/splitter 110, two modulating arms 111, 112 to which bias can be applied, and an output 2×2 MMI coupler/splitter 113. Modulated light is transmitted from an output 114 of the output coupler/splitter 113. A monitor 115 may be included on the complementary (quadrature) output 116 of the output coupler/splitter 113.

The laser assembly also includes additional DBR electrodes 104, 204 adjacent to the rear DBR electrodes 103, 203, and additional SOA electrodes 109, 209 adjacent to the SOAs 108, 208. Current is provided to the additional electrodes 104, 204, 109, 209 so that the sum current provided to each electrode and its corresponding additional electrode remains constant, even when the current to a particular electrode changes, as will be explained in more detail below. The additional electrodes may “dummy” electrodes designed simply to provide current compensation, but it will be appreciated that they could be functional electrodes if appropriate.

In operation (controlled by a control system (not shown), both lasers 101 and 201 are operated so as to generate continuous wave (cw) laser light. The SOAs 108, 208 are operated to switch transmission of light from each laser so that, at any given moment, only one of the two lasers transmits light into the modulator 102.

In order to provide fast wavelength switching between packets, light from the lasers 101, 201, is transmitted alternately, so that light from one “active” laser is transmitted while the other laser is re-tuned to transmit at a different wavelength.

In other words, the assembly is configured so that, initially, the first SOA 108 (for example) transmits light so that the first laser transmits light into the modulator 102 (I.e. the first laser is currently the active laser). A signal corresponding to one or more data packets is imposed on this light which is sent via the output 114. While the first laser 101 transmits, current applied to the rear DBR 203, phase section 205 and front DBR 207 of the second laser 201 is changed to re-tune the second laser to transmit at a new wavelength. The SOA 208 blocks light from the second laser 201 while the re-tuning takes place.

When the wavelength switch is required, the first SOA 108 is switched so as to block light, and the second SOA is switched so as to transmit light. Light from the second laser 201 at the new wavelength is now transmitted into the modulator 102 for subsequent data packets to be incorporated. The second laser 201 is thus now the active laser. While light from the first laser 101 is blocked by the first SOA 108, current is applied to its DBRs 103, 107 and phase section 105 to re-tune it to another new wavelength. Thus light from the lasers 101, 201 is transmitted in sequence at different wavelengths, with one laser being retuned while the other is active.

This arrangement means that there is no need to re-tune either laser in the gap between two successive packets (10 ns). Instead, each laser needs to be re-tuned in a timescale of the order of a length of a packet (200 ns).

It will be appreciated that re-tuning the lasers 101, 201 involves a change in the current injected into each rear DBR 103, 203, phase section 105, 205 and front DBR 107, 207. The largest current change is in the rear DBR 103, 203. In order to prevent this current change resulting in a significant change in temperature of the laser 101, 201, current provided to each additional DBR electrode 104, 204 “mirrors” the current injected to the rear DBR 103, 203 so that the total current supplied to the DBR 103, 203 and additional DBR electrode 104, 204 remains constant. The heating effect of these two electrodes therefore remains substantially constant and this helps to prevent thermal settling (and consequent wavelength drift) for each laser 101, 201.

Similarly, the current change involved in switching the SOAs 108, 208 is relatively large, and the current supplied to the additional SOA electrodes 109, 209 mirrors that supplied to the SOAs 108, 208 themselves so that, again, the heating effect remains substantially constant. If necessary, additional electrodes could be added adjacent to the phase sections 105, 205 and front DBRs 107, 207 of the lasers 101, 201 if necessary, although the current changes in these sections are relatively small. The current supplied to each gain section 106, 206 does not change during a wavelength switching event so additional electrodes are, in general, not required. It will be appreciated that, in practice, additional component electrodes can be placed adjacent to any thermally sensitive control components (reflectors, SOAs, etc.) associated with each laser.

FIG. 2 is a cross-section through the rear DBR section of both lasers 101, 102 along the line 2-2 in FIG. 1. The cross section illustrates a substrate 221 on which a waveguide core 222 and cladding 223 is deposited. The additional DBR electrodes 104, 204 are placed as close as possible to the “real” DBR electrodes 103, 203 (shown in FIG. 2 with optical modes 120, 220 beneath them) in order to minimise the thermal settling time of the “real” section. The distance between the lasers is greater than (or at least equal to) the substrate thickness, which is typically of the order of 100 μm so as to minimize the thermal coupling between them. This ensures that, during wavelength switching, the active laser is not perturbed by the other laser being re-tuned.

It is also apparent from FIG. 2 that the device could easily be formed monolithically, with both lasers 101, 201 (and possibly also the modulator 102) on the same substrate.

The embodiment illustrated in FIG. 1 has no intrinsic optical loss, but it will be noted that data will be inverted when switching between the lasers 101, 201, as a result of the phase characteristics of the 2×2 coupler/splitter 113 (the output arms of the coupler 113 are out of phase by ±90°). This could be rectified by controlling the modulation in the modulator 102 to correct for this, or by ensuring that receivers know which packets will have inverted data, enabling them to correct for it.

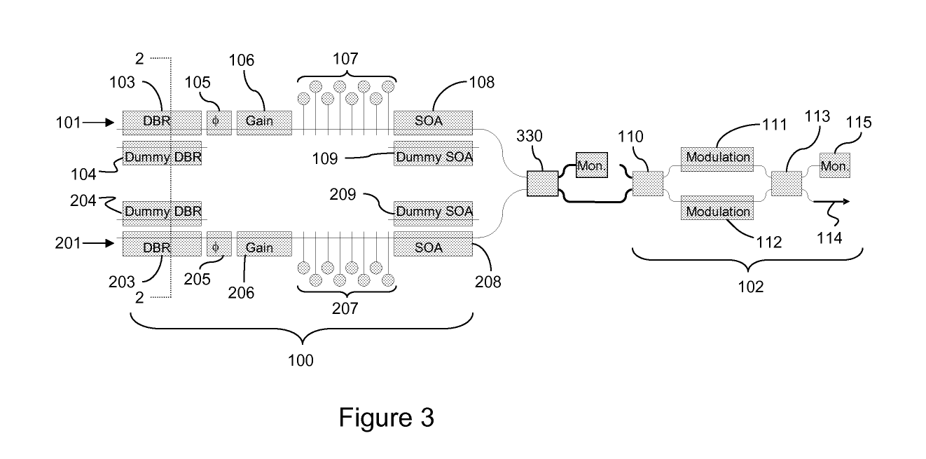

FIG. 3 is a schematic illustration of an assembly which overcomes the problem of inverted data. The components of the assembly of FIG. 3 are broadly similar to those of FIG. 1 and are illustrated by the same reference numerals. The arrangement of FIG. 3 differs from that of FIG. 1 in that a combiner 330 is included between the laser assembly 100 and modulator 102. This means that only one input arm of the input coupler/splitter 113 is used to supply light from both lasers 101, 201 to the modulator 102. This overcomes the data inversion problem, although it introduces an extra 3 dB of optical loss into the system.

It will be appreciated that variations from the above embodiments may still fall within the scope of the invention. For example, the arrangements have been described with reference to DS-DBR lasers, but it will be appreciated that other types of tuneable lasers may be used. In particular, it will be appreciated that the same approach can be put into effect using SG-DBR lasers such as those described in U.S. Pat. No. 4,896,325 or U.S. Pat. No. 5,379,318. SG-DBR lasers have Vernier tunable DBRs either side of a gain section and phase section, and current is injected to the DBRs to tune the wavelength. One such laser may transmit at one wavelength while the other is tuned to a different wavelength in the same way as for the DS-DBR lasers described above. Furthermore, additional electrodes may be placed adjacent to either of both of the reflectors (and, if necessary, phase sections) of such lasers to assist with thermal settling.

Furthermore, if appropriate, more than two lasers may be used, although this may be difficult due to space constraints.

In addition, the laser assembly has been described with two separate SOAs 108, 208, one provided on the output of each laser 101, 201. It will be appreciated that selecting light from one or other lasers could be achieved using other forms of switching.

1. A laser assembly for providing light at a switchable output wavelength, comprising first and second tuneable lasers, each configurable to emit light at a laser wavelength chosen from a range of wavelengths, wherein:
the assembly is configured to transmit light from the first laser while the second laser is retuned to change the chosen laser wavelength thereof; and
each laser comprises:
one or more thermally sensitive control components for controlling the operation of the laser; and
an additional component electrode located adjacent to at least one of the one or more control components and configured so that the sum of electrical currents supplied to each control component and its corresponding additional component electrode remains substantially constant in use.

2. The assembly of claim 1, configured to switch the output wavelength by switching to transmission of light from the second laser at the changed laser wavelength.

3. The assembly of claim 2, configured so that, while the light from the second laser is transmitted, the first laser is retuned so as to change the laser wavelength thereof.

4. The assembly of claim 3, wherein each additional component electrode is located within approximately 10 μm of its corresponding control component so that there is strong thermal coupling between the additional component electrode and the corresponding control component.

5. The assembly of claim 1, wherein each laser comprises a rear reflector, gain section and front reflector and the one or more thermally sensitive control components include the front and/or rear reflector.

6. The assembly of claim 5, wherein the lasers are Digital Supermode Distributed Bragg Reflector lasers, the rear reflectors are phase change Bragg reflectors and the front reflectors are chirped Bragg reflectors.

7. The assembly of claim 6, wherein the additional component electrodes are located adjacent to the phase change Bragg reflectors.

8. The assembly of claim 5, wherein the lasers are Sampled Grating Distributed Bragg Reflector lasers, and the front and rear reflectors are sampled Bragg reflectors.

9. The assembly of claim 1, further comprising first and second transmission switches coupled to outputs of the first and second lasers respectively and configured to selectively block and transmit light emitted by their respective laser.

10. The assembly of claim 9, wherein the one or more control components include the transmission switches and the additional control electrodes include first and second additional switch electrodes located adjacent the first and second transmission switches respectively and configured so that the sum of electrical currents supplied to each transmission switch and its corresponding additional switch electrode remains substantially constant in use.

11. The assembly of claim 9, wherein the transmission switches are semiconductor optical amplifiers.

12. The assembly of claim 9, wherein each laser is monolithically integrated on a single substrate with its corresponding transmission switch and one or more additional component electrodes.

13. The assembly of claim 1, wherein both lasers are monolithically integrated on a single substrate.

14. The assembly of claim 13, wherein the lasers are spaced apart by a distance equal to or greater than the thickness of the substrate.

15. The assembly of claim 1, wherein each additional component electrode is a dummy electrode.

16. A wavelength switchable transmission assembly comprising a laser assembly for providing light at a switchable output wavelength and a modulator, configured so that light emitted from the laser assembly is propagated into the modulator, wherein:
the laser assembly comprises first and second tuneable lasers, each configurable to emit light at a laser wavelength chosen from a range of wavelengths;
the assembly is configured to transmit light from the first laser while the second laser is retuned to change the chosen laser wavelength thereof; and
each laser comprises:
one or more thermally sensitive control components for controlling the operation of the laser; and
an additional component electrode located adjacent to at least one of the one or more control components and configured so that the sum of electrical currents supplied to each control component and its corresponding additional component electrode remains substantially constant in use.

17. The transmission assembly of claim 16, further comprising an optical coupler/splitter having two inputs and two outputs, wherein light emitted from the first laser is propagated into one of the inputs and light emitted from the second laser is propagated into the other of the inputs, and wherein the two outputs are coupled to modulation arms of the modulator.

18. The transmission assembly of claim 16, further comprising a combiner having two inputs and at least one output wherein light emitted from the first laser is propagated into one of the inputs and light emitted from the second laser is propagated into the other of the inputs, and wherein the combiner is configured so that light entering either of the inputs is transmitted from the output.

19. The transmission assembly of claim 16, wherein the laser assembly and modulator are monolithically integrated on a single substrate.

20. A method of transmitting light having a wavelength which changes in discrete steps over time, comprising:
transmitting light at a first wavelength from a first laser comprising one or more thermally sensitive control components;
retuning a second laser comprising one or more thermally sensitive control components to emit light at a second wavelength while the light is transmitted from the first laser;
switching wavelength by stopping transmission of light at the first wavelength from the first laser and starting transmission of light at the second wavelength from the second laser;
when the first or second laser is retuned, changing a current injected to at least one of the one or more thermally sensitive control components of that laser; and
changing a current directed to an additional component electrode located adjacent to the at least one control component so that the sum of the currents supplied to the control component and additional component electrode remains substantially constant.

21. The method of claim 20, further comprising retuning the first laser to emit light at a third wavelength while the light at the second wavelength is transmitted from the second laser.

22. The method of claim 20, wherein each laser comprises a rear Distributed Bragg Reflector, gain section and front Distributed Bragg Reflector and the one or more thermally sensitive control components include one or both of the reflectors.

23. The method of claim 20, wherein controlling transmission of light from the lasers is carried out by changing current injected to semiconductor optical amplifiers coupled to outputs of the lasers, the method further comprising changing current directed to additional switch electrodes located adjacent to the amplifiers so that the total current supplied to one of the amplifiers and its associated additional switch electrode remains substantially constant.

24. The method of claim 20, further comprising:
propagating light emitted from the first or second laser into a modulator;
applying a signal to modulate the light; and
transmitting the modulated light.

25. The method of claim 24, wherein the signal comprises data packets, and wherein the step of switching wavelength is effected between adjacent data packets.
